(19) United States
(12) Patent Application Publication
(10) Pub. No.: US 2021/0005028 A1
(43) Pub. Date: Jan. 7, 2021

(54) INFORMATION PROCESSING DEVICE, INFORMATION PROCESSING SYSTEM, AND CONTROL METHOD

(71) Applicant: SHARP KABUSHIKI KAISHA, Sakai City (JP)

(72) Inventor: JUNICHI SHIRAKAWA, Sakai City (JP)

(21) Appl. No.: 16/917,847

(22) Filed: Jun. 30, 2020

(30) Foreign Application Priority Data
Jul. 2, 2019 (JP) 2019-123468

(51) Int. Cl. G07C 5/02; G06K 9/62; G07C 5/00; G06K 9/20

(52) U.S. Cl. CPC G07C 5/02; G06K 9/209; G07C 5/008; G06K 9/6215

(57) ABSTRACT

An information processing device according to an aspect of the present disclosure is provided with an acquisition unit that acquires a plurality of pieces of sensor information from a plurality of drive recorders, respectively, a comparison unit that compares first sensor information included in the plurality of pieces of sensor information with second sensor information included in the plurality of pieces of sensor information, and an association unit that, in accordance with a result of the comparison, associates a first drive recorder that has output the first sensor information and a second drive recorder that has output the second sensor information with each other, as two drive recorders mounted on the same vehicle.

### CROSS-REFERENCE TO RELATED APPLICATION

This application claims the benefit of priority to Japanese Patent Application Number 2019-123468 filed on Jul. 2, 2019. The entire contents of the above-identified application are hereby incorporated by reference.

### BACKGROUND OF THE INVENTION

### 1. Field of the Invention

The present disclosure relates to an information processing device, or the like.

### 2. Description of the Related Art

In JP 2001-61129 A, a technology is disclosed that can record and reproduce, in a superimposed manner, image data having a plurality of fields of view, traveling data of a vehicle, abnormality data detected by a plurality of sensor devices, and the like.

### SUMMARY OF THE INVENTION

A drive recorder system described in JP 2001-61129 A can simply record and reproduce the above-described abnormality data and the like in a superimposed manner.

An object of an aspect of the present disclosure is to realize an information processing device or the like capable of providing a wide range of services to a user using a plurality of drive recorders.

An information processing device according to an aspect of the present disclosure includes an acquisition unit configured to acquire a plurality of pieces of sensor information from a plurality of drive recorders, respectively, a comparison unit configured to compare first sensor information included in the plurality of pieces of sensor information with second sensor information included in the plurality of pieces of sensor information, and an association unit configured to associate, in accordance with a result of the comparison, a first drive recorder outputting the first sensor information and a second drive recorder outputting the second sensor information with each other, as two drive recorders mounted on a same vehicle.

A control method of an information processing device according to an aspect of the present disclosure includes acquiring a plurality of pieces of sensor information from a plurality of drive recorders, respectively, comparing first sensor information included in the plurality of pieces of sensor information with second sensor information included in the plurality of pieces of sensor information, and associating, in accordance with a result of the comparison, a first drive recorder outputting the first sensor information and a second drive recorder outputting the second sensor information with each other, as two drive recorders mounted on a same vehicle.

A control program of an information processing device according to an aspect of the present disclosure causes the information processing device to realize an acquisition function that acquires a plurality of pieces of sensor information from a plurality of drive recorders, respectively, a comparison function that compares first sensor information included in the plurality of pieces of sensor information with second sensor information included in the plurality of pieces of sensor information, and an association function that, in accordance with a result of the comparison, associates a first drive recorder outputting the first sensor information and a second drive recorder outputting the second sensor information with each other, as two drive recorders mounted on a same vehicle.

### BRIEF DESCRIPTION OF THE DRAWINGS

The disclosure will be described with reference to the accompanying drawings, wherein like numbers reference like elements.

FIG. 1 is a block diagram illustrating an example of a configuration of main portions of a server according to an aspect of the present disclosure.

FIG. 2 is a system configuration diagram illustrating a configuration of an information processing system according to an aspect of the present disclosure and an image processing system according to an aspect of the present disclosure.

FIG. 3 is an example of a data structure configured in a storage memory provided in the server.

FIG. 4A and FIG. 4B illustrate an example of image-related data stored in the storage memory provided in the server, where FIG. 4A is an example of the data structure configured in the storage memory, and FIG. 4B is an example of an image stored in the storage memory.

FIG. 5 is a graph illustrating an example of sensor information acquired by the server.

FIG. 6 is a timing chart illustrating an example of processing performed in the information processing system.

FIG. 7 is a flowchart illustrating an example of drive recorder registration processing.

FIG. 8 is a flowchart illustrating an example of image registration processing.

### DETAILED DESCRIPTION OF THE INVENTION

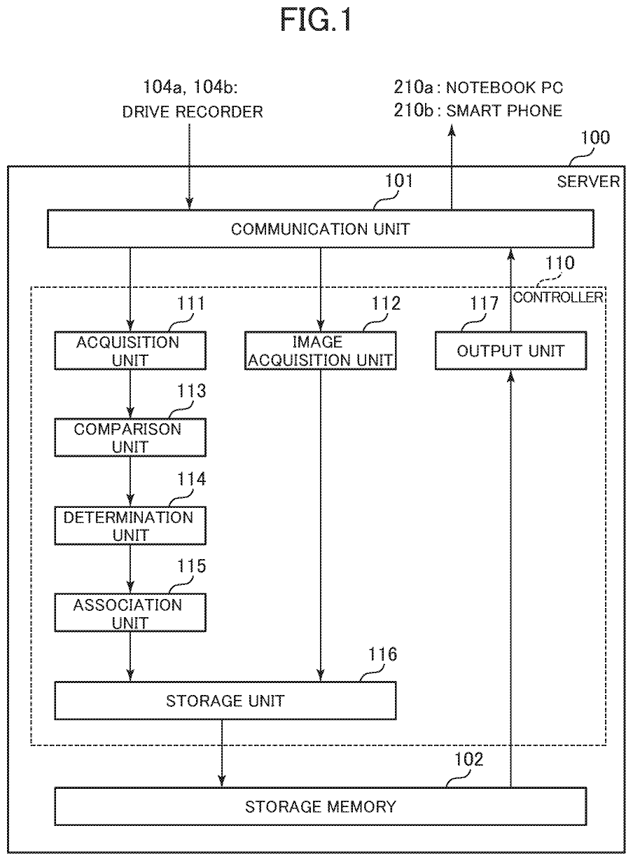

An aspect of the present disclosure will be described with reference to FIGS. 1 to 8. In the drawings, identical or equivalent elements are given the same reference signs, and redundant descriptions thereof are omitted.

### Overview of Server 100

FIG. 1 is a block diagram illustrating an example of a configuration of main portions of a server 100. First, an overview of the server 100 will be described.

When a user has installed a plurality of drive recorders in the same vehicle (a passenger car, a bus, a truck, a motorbike, or the like, for example), it is preferable that the server 100, which is communicably connected to the plurality of drive recorders, can acquire information relating to the fact that the plurality of drive recorders “have been mounted on the same vehicle.” This is because certain effects can be expected, such as expanding a range of services that can be provided for the user by the server 100, for example.

However, in order for the server 100 to be aware of the above-described fact, it is necessary for the user to go to some trouble, for example, to pair up two of the drive recorders and transmit a result of the paring to the server 100.

Here, the server 100 acquires a plurality of pieces of sensor information (sensor information 1a and sensor information 1b, for example, as illustrated in FIG. 1) from a plurality of the drive recorders (a drive recorder 104a and a drive recorder 104b, for example), respectively, and compares the sensor information 1a with the sensor information 1b. Then, based on the comparison result, the server 100 associates the drive recorder 104a from which the sensor information 1a has been acquired, with the drive recorder 104b from which the sensor information 1b has been acquired, as the two drive recorders mounted on the same vehicle, for example.

As a result, the server 100 can determine whether the two drive recorders are mounted on the same vehicle without asking the user to take the above-described trouble, and can provide a wide range of services to the user, for example.

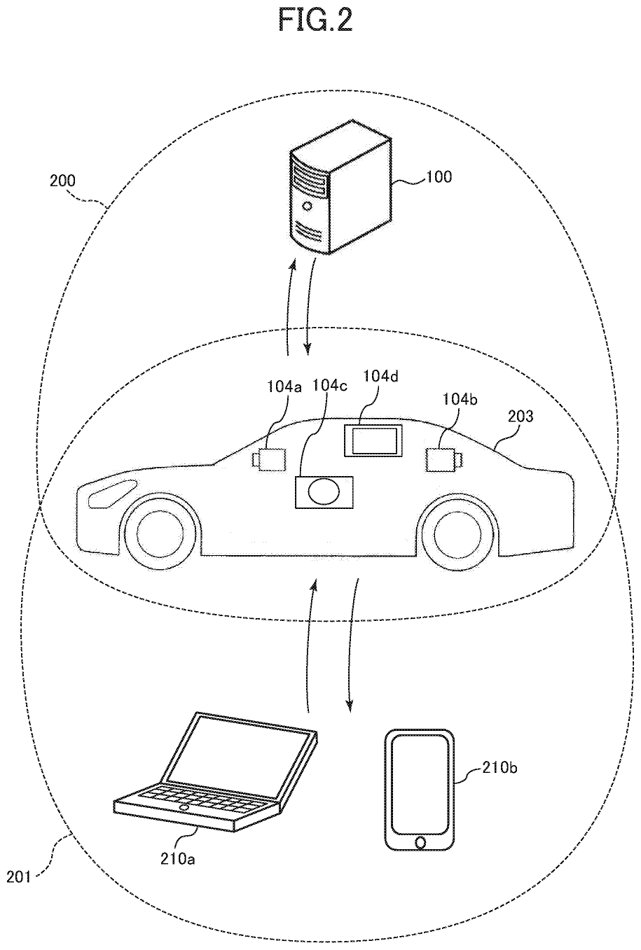

Note that in the following description, “the plurality of drive recorders” represents the drive recorder 104a and the drive recorder 104b mounted on the vehicle, as illustrated in FIG. 1. However, it is sufficient that a number of the drive recorders be two or more, and the number is not limited to two (a configuration in which four of the drive recorders are provided will be described below with reference to FIG. 2, for example).

Further, in the following description, “the plurality of pieces of sensor information” represents the sensor information 1a acquired from the drive recorder 104a and the sensor information 1b acquired from the drive recorder 104b. However, it should be noted that when the number of drive recorders is increased, the number of pieces of sensor information acquired by the server 100 may be increased proportionally to the increase in the number of drive recorders.

### Configuration of Server 100

Next, a configuration of the server 100 will be described.

As illustrated in FIG. 1, the server (information processing device) 100 may be provided with a communication unit 101, a storage memory 102, and a controller 110 (an acquisition unit 111, an image acquisition unit 112, a comparison unit 113, a determination unit 114, an association unit 115, a storage unit 116, and an output unit 117), for example.

The controller 110 has a function of integrally controlling various types of functions of the server 100, and is realized by a controller (a processor) such as a central processing unit (CPU), for example.

The communication unit 101 transmits and receives, to and from the plurality of drive recorders and user terminals (a notebook PC 210a and a smart phone 210b, for example, as illustrated in FIG. 2), data such as sensor information, images, device information, user information, and the like, via a network, for example. Note that the communication unit 101 may be a hardware capable of communicating with an external device via a network compliant with a prescribed communication method. It is sufficient that the communication unit 101 be provided with an essential function for realizing the communication with the external device, and a communication channel, communication method, communication medium, and the like are not limited.

The acquisition unit 111 may acquire the plurality of pieces of sensor information from the plurality of drive recorders, respectively, and output the plurality of pieces of sensor information to the comparison unit 113, for example. At this time, the acquisition unit 111 may acquire the plurality of pieces of sensor information in a time series manner, for example.

Further, the acquisition unit 111 may acquire the user information (a user name, a user ID, and the like, for example) that can identify the user of the drive recorder 104a, and may output the user information to the comparison unit 113, for example. Note that the acquisition unit 111 may acquire information based on at least one of a position, acceleration, and vibration as the plurality of pieces of sensor information, for example. However, the sensor information may include other information (a speed, an angle, a direction, an altitude, a time, and the like).

The comparison unit 113 may compare the sensor information (first sensor information) 1a included in the plurality of pieces of sensor information with the sensor information (second sensor information) 1b included in the plurality of pieces of sensor information, and may output the comparison result to the determination unit 114, for example.

The comparison unit 113 may evaluate a degree of similarity between the sensor information 1a and the sensor information 1b, for example. Further, the comparison unit 113 may compare the sensor information 1a and the sensor information 1b in a time series manner, for example. Note that the processing of comparing the plurality of pieces of sensor information by the comparison unit 113 will be described below in detail.

In accordance with the result obtained by the comparison unit 113 comparing the sensor information 1a and the sensor information 1b, the association unit 115 may associate the drive recorder 104a, from which the sensor information 1a has been acquired, and the drive recorder 104b, from which the sensor information 1b has been acquired, as the two drive recorders mounted on the same vehicle, and may output the association result to the storage unit 116, for example.

In addition, when the determination unit 114 determines that the drive recorder 104a and the drive recorder 104b are mounted on the same vehicle, the association unit 115 may associate the drive recorder 104a with the drive recorder 104b, and output the association result to the storage unit 116, for example. Further, the association unit 115 may further associate the user information of the drive recorder 104a with the drive recorder 104b, and output the association result to the storage unit 116, for example.

Furthermore, the association unit 115 may associate device information of the drive recorder 104a with device information of the drive recorder 104b, and output the association data (a group ID) to the storage unit 116, for example. Note that the processing of associating the two drive recorders by the association unit 115 will be described below in detail.

Further, when the comparison result of the first sensor information and the second sensor information satisfies a prescribed condition, or in accordance with the degree of similarity representing the comparison result, the association unit 115 may associate the first drive recorder that has output the first sensor information and the second drive recorder that has output the second sensor information, as the two drive recorders mounted on the same vehicle, for example.

In accordance with the result obtained by the comparison unit 113 comparing the sensor information 1a and the sensor information 1b, the determination unit 114 may determine whether the drive recorder 104a and the drive recorder 104b are mounted on the same vehicle, for example. Specifically, the determination unit 114 may determine whether the drive recorder 104a and the drive recorder 104b are mounted on the same vehicle in accordance with the degree of similarity evaluated by the comparison unit 113.

For example, when the degree of similarity evaluated by the comparison unit 113 is within a prescribed range, the determination unit 114 may determine that the drive recorder 104a and the drive recorder 104b are mounted on the same vehicle, and the determination unit 114 may determine whether the drive recorder 104a and the drive recorder 104b are mounted on the same vehicle in accordance with a time period or a number of times by which a comparison result indicating the result of the comparison by the comparison unit 113 satisfies a prescribed condition, for example. Note that the above-described determination processing by the determination unit 114 will be described below in detail.

The image acquisition unit 112 may acquire a plurality of images 3a and 3b from the plurality of drive recorders, respectively, and output the plurality of images 3a and 3b to the determination unit 114, for example. Note that in the following description, the “plurality of images” will represent the image 3a acquired from the drive recorder 104a and the image 3b acquired from the drive recorder 104b. However, it should be noted that when the number of drive recorders is increased, the number of images acquired by the server 100 may be increased proportionally to the increase in the number of drive recorders.

Further, the image acquisition unit 112 may transmit an image request signal, which requests transmission of a captured image, to each of the plurality of associated drive recorders via the communication unit 101, for example. Note that when the plurality of images are input from the image acquisition unit 112, the determination unit 114 may output the plurality of images to the storage unit 116.

When the drive recorder 104a and the drive recorder 104b are associated with each other, the storage unit 116 may store the image 3a acquired from the drive recorder 104a and the image 3b acquired from the drive recorder 104b in the storage memory 102, while associating the image 3a with the image 3b, for example.

For example, the storage unit 116 may store the group ID assigned to the device information corresponding to the drive recorder 104a, and the device information corresponding to the drive recorder 104b in the storage memory 102. Note that the data stored in the storage memory 102 by the storage unit 116 will be described below in detail.

The output unit 117 may output the image 3a acquired from the drive recorder 104a and the image 3b acquired from the drive recorder 104b to a terminal used by the user (the user terminal) while associating the image 3a with the image 3b. Note that the output unit 117 may output the image 3a and the image 3b to the communication unit 101, while associating the image 3a with the image 3b.

The storage memory 102 is a storage device capable of storing any information, and may be configured, for example, by a hard disk, a silicon state drive (SSD), a semiconductor memory, a DVD, or the like.

Note that each of the units included in the controller 110 may be arbitrarily rearranged depending on, for example, the purpose of processing performed by the server 100, and the like. For example, cases in which the controller 110 includes some or all of the units, and in which the controller 100 does not include some or all of the units, are all included in the scope of the present disclosure as modified examples of the embodiment that can be designed as appropriate.

Configuration of Information Processing System 200

FIG. 2 is a system configuration diagram illustrating a configuration of an information processing system 200 and an image processing system 201.

The information processing system 200 may include the server 100 and drive recorders 104a to 104d, for example. Note that FIG. 2 illustrates an example of the configuration of the information processing system 200, and does not limit the configuration of the information processing system 200 to the configuration illustrated in FIG. 2. Further, unlike in FIG. 1, in which it is assumed that the two drive recorders 104a and 104b are mounted on the vehicle, in FIG. 2, it is assumed that the four drive recorders 104a to 104d are mounted on a vehicle 203.

Each of the drive recorders is provided with a sensor and a camera, for example, and is communicably connected to the server 100. Note that each of the drive recorders may communicate with the server 100 via a chosen communication terminal (the vehicle 203, a GPS tracker, a smart phone, or the like, for example).

For example, each of the drive recorders may be connected to the GPS tracker using Wi-Fi (trade name) or Bluetooth (trade name), and may communicate with the server 100 via the GPS tracker. Then, each of the drive recorders may transmit the plurality of pieces of sensor information (sensor information 1a to 1d, for example) and the plurality of images (images 3a to 3d, for example) to the server 100.

### Configuration of Image Processing System 201

The image processing system (information processing system) 201 is configured to include the server 100 and a notebook PC (user terminal) 110a, for example. Note that FIG. 2 illustrates an example of the configuration of the image processing system 201, and does not limit the configuration of the image processing system 201 to the configuration illustrated in FIG. 2.

As illustrated in FIG. 2, the image processing system 201 further includes a smart phone (user terminal) 110b, but it is sufficient that at least one of the user terminals be included in the image processing system 201.

The notebook PC 110a and the smart phone 110b may be communicably connected to the server 100, for example, and receive the images captured by each of the drive recorders from the server 100. Note that the notebook PC 110a and the smart phone 110b display the images and present the images to the user, for example.

### Data Structure for Associating Plurality of Drive Recorders

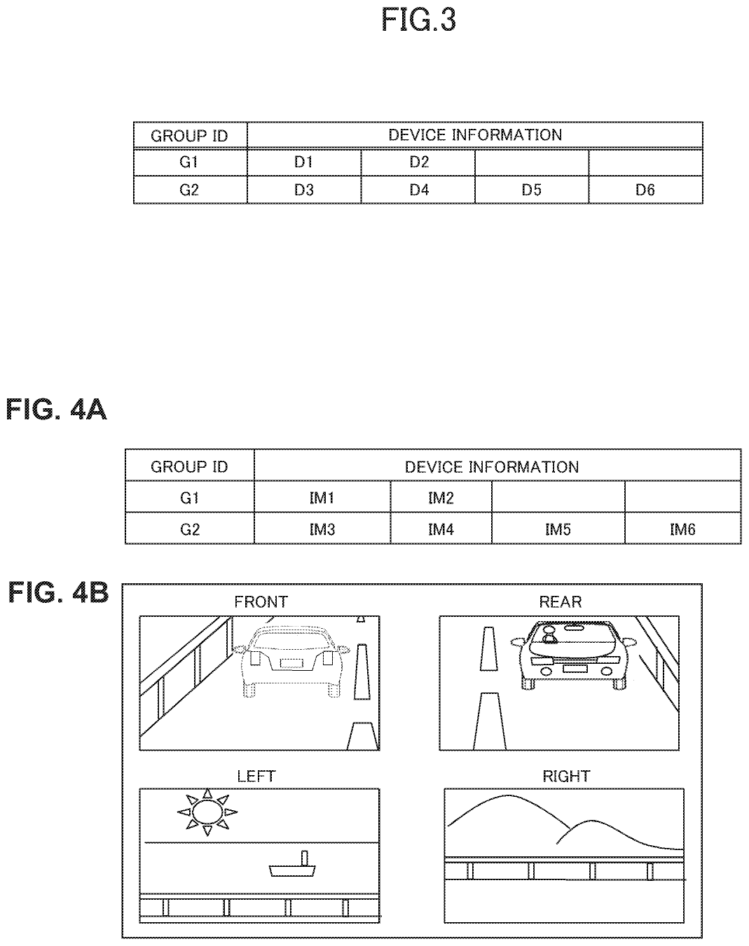

FIG. 3 is an example of a data structure configured in the storage memory 102 provided in the server 100. As illustrated in FIG. 3, the group ID may be stored in the storage memory 102 using a data structure of a table format.

Here, when the plurality of drive recorders are associated with each other, the group ID may be unique identification information assigned to a plurality of pieces of the device information respectively corresponding to the plurality of drive recorders, for example. In other words, with reference to the group ID, the server 100 can ascertain that the plurality of drive recorders are associated with each other.

Specifically, the group ID may be, for example, vehicle information identifying the same vehicle on which the plurality of drive recorders are mounted, user information of the user who owns the drive recorders, or the like.

Further, for example, the device information may be information identifying each of the drive recorders (a MAC address, a manufacturing number, a model name, or the like of the drive recorder, for example). In the following description, “the plurality of pieces of device information” represents the device information corresponding to each of the plurality of drive recorders.

As illustrated in FIG. 3, a drive recorder having device information “D1” and a drive recorder having device information “D2” are stored in the storage memory 102 in a state of being identifiable by a group ID “G1.” In other words, the server 100 can identify that the two drive recorders are associated with each other by the group ID “G1.”

Similarly, a drive recorder having device information “D3,” a drive recorder having device information “D4,” a drive recorder having device information “D5,” and a drive recorder having device information “D6” are stored in the storage memory 102 in a state of being identifiable by a group ID “G2.” In other words, the server 100 can identify that the four drive recorders are associated with each other by the group ID “G2.”

Note that the above-described table is configured by information processing, which will be described next. When the determination unit 114 outputs, to the association unit 115, the plurality of pieces of device information corresponding to the plurality of drive recorders, which have been determined as being mounted on the same vehicle, the association unit 115 assigns the group ID to the plurality of pieces of device information, and outputs the group ID and the plurality of pieces of device information to the storage unit 116. The storage unit 116 stores those data in the storage memory 102 in the format illustrated in FIG. 3.

In other words, the storage unit 116 may store the association result to the storage memory 102 as identification information (group ID) indicating that the plurality of drive recorders belong to one group, while associating the plurality of pieces of device information respectively corresponding to the plurality of drive recorders with the identification information.

According to the above-described configuration, the server 100 can ascertain that the plurality of drive recorders are associated with each other by simply referring to the storage memory 102.

### Data Structure for Identifying Plurality of Images

FIG. 4A and FIG. 4B illustrate an example of image-related data stored in the storage memory 102 provided in the server 100, where FIG. 4A is an example of a data structure configured in the storage memory 102, and FIG. 4B is an example of an image stored in the storage memory 102.

As illustrated in FIG. 4A, an image having image information “IM1” (the image 3a captured by the drive recorder 104a, for example) and an image having image information “IM2” (the image 3b captured by the drive recorder 104b, for example) are stored in the storage memory 102 in a state of being identifiable by the group ID “G1.” In other words, based on the group ID, the server 100 can identify that the two images have been captured by the two drive recorders that are associated with each other.

Similarly, an image having image information “IM3” (an image 2c captured by the drive recorder 104c), an image having image information “IM4” (an image 2d captured by the drive recorder 104d), an image having image information “IM5” (an image 2e captured by a drive recorder 104e, for example), and an image having image information “IM6” (an image 2f captured by a drive recorder 104f) are stored in the storage memory 102 in a state of being identifiable by the group ID “G2.” In other words, based on the group ID, the server 100 can identify that the four images have been captured by the four drive recorders that are associated with each other.

Further, the storage unit 116 may store the association result in the storage memory 102 as the identification information (group ID) indicating that the plurality of drive recorders belong to one group, while associating information based on the images acquired from each of the plurality of drive recorders and the identification information, for example.

As illustrated in FIG. 4B, the server 100 can cause the above-described four images to be displayed on the notebook PC 210a (or the smart phone 210b). Here, while using a case in which the drive recorders 104c to 104f are respectively capturing images of the front, the rear, the left, and the right of the vehicle 203 as an example, an example of processing for displaying the four images using the server 100 in a format illustrated in FIG. 4B will be described.

First, the image acquisition unit 112 acquires the front image 2c, the rear image 2d, the left image 2e, and the right image 2f from the drive recorders 104c to 104f, respectively. Next, when the image acquisition unit 112 confirms that the above-described four drive recorders are associated with each other by reading the group ID from the storage memory 102, the image acquisition unit 112 outputs the four images to the storage unit 116. Then, the storage unit 116 stores the four images in the storage memory 102 in the format illustrated in FIG. 4A. Finally, the output unit 117 reads the images 2c to 2f from the storage memory 102, and transmits the images 2c to 2f to the notebook PC 210a via the communication unit 101.

In other words, based on the images acquired from the two drive recorders, the output unit 117 may output, to the user terminal, information that enables identification of a positional relationship between the two drive recorders in the same vehicle, for example.

### Processing of Comparing Plurality of Pieces of Sensor Information by Server 100

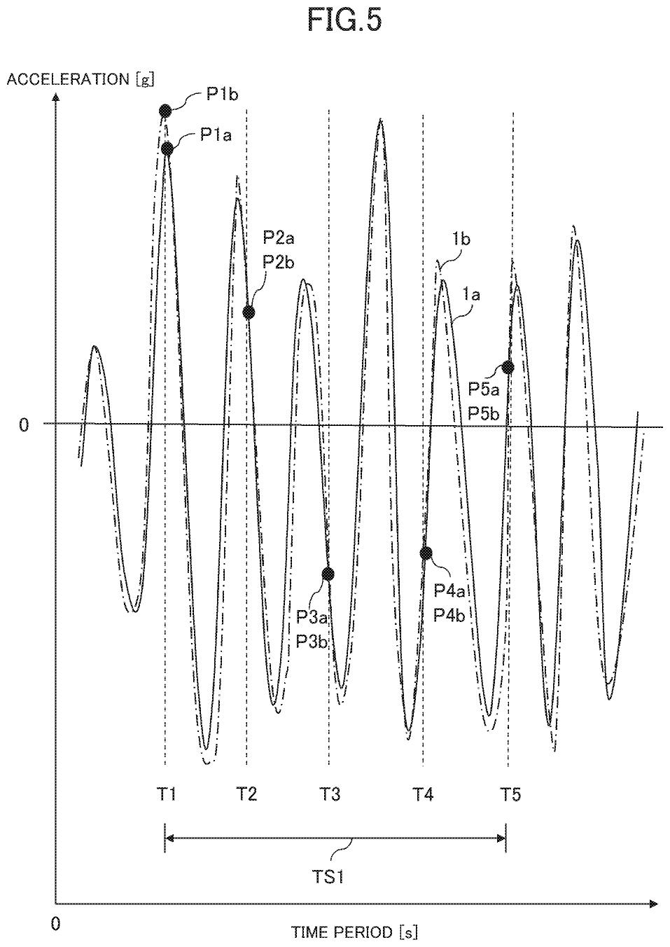

FIG. 5 is a graph illustrating an example of the sensor information acquired by the server 100. Since the sensor information may include the acceleration, for example, FIG. 5 illustrates a waveform plotting the acceleration.

For example, the acquisition unit 111 may acquire the plurality of pieces of sensor information a plurality of times in a time series manner, from the plurality of drive recorders at each of a prescribed timing (every one second, for example). For example, the acquisition unit 111 acquires a plurality of the accelerations included in the plurality of pieces of sensor information at times T1 to T5 (in other words, over each of a time period corresponding to an interval between the times).

Then, the comparison unit 113 compares an acceleration P1a included in the sensor information 1a acquired at the time T1 with an acceleration P1b included in the sensor information 1b. Similarly, the comparison unit 113 compares the acceleration included in the sensor information 1a with the acceleration included in the sensor information 1b at each of the other times (T2 to T5), in the same manner.

Specifically, for example, the comparison unit 113 may calculate a proximity between the acceleration P1a (4, for example) and the acceleration P1b (5, for example) at the time T1, as a percentage of the acceleration P1a relative to the acceleration P1b (in this case 0.8), and may evaluate the calculation result as the degree of similarity.

Similarly, the comparison unit 113 may calculate a proximity between an acceleration P2a (2.5, for example) and an acceleration P2b (2.5, for example) at the time T2, as a percentage of the acceleration P2a relative to the acceleration P2b (in this case 1), and may evaluate the calculation result as the degree of similarity.

In other words, the comparison unit 113 may compare the first sensor information with the second sensor information by using a percentage of a first measurement value, which is part of the first sensor information included in the plurality of pieces of sensor information, relative to a second measurement value, which is part of the second sensor information included in the plurality of pieces of sensor information, for example.

As a result, since the server 100 can accurately compare the plurality of pieces of sensor information, an accuracy in determining whether the two drive recorders are mounted on the same vehicle can be increased, for example. Accordingly, the server 100 can provide a wide range of services to the user, for example.

Note that the comparison unit 113 may evaluate the degree of similarity in the same manner as described above, not only for the acceleration, but also for other measurement values included in the sensor information 1a and the sensor information 1b.

Processing for Determining that Drive Recorders are Mounted on the Same Vehicle

When the degree of similarity between the sensor information 1a and the sensor information 1b evaluated by the comparison unit 113 satisfies the prescribed condition, the determination unit 114 may determine that the two drive recorders (the drive recorder 104a and the drive recorder 104 b, for example) are mounted on the same vehicle, for example.

For example, the determination unit 114 may determine whether the degree of similarity is equal to or greater than a prescribed threshold (0.7, for example), and may determine that the two drive recorders are mounted on the same vehicle if the degree of similarity is equal to or greater than the prescribed threshold.

Alternatively, for example, the determination unit 114 may acquire a time period or a number of times by which the acceleration P1a and the acceleration P1b satisfy the prescribed condition (being equal to or greater than the threshold value, for example), and may make the determination based on the time period or the number of times. For example, the determination unit 114 measures a time period TS1 (a time period between T1 and T5 in FIG. 5) during which the above-described degree of similarity continuously satisfies the prescribed condition. Then, the determination unit 114 may determine whether the time period exceeds a prescribed time period (one minute, for example), and if so, may determine that the two drive recorders are mounted on the same vehicle.

Alternatively, the determination unit 114 counts the number of times the degree of similarity satisfies the prescribed condition, for example. Then, the determination unit 114 may determine whether the number of times exceeds a prescribed number of times (four times in total within a prescribed time period, ten consecutive times, or the like, for example) and if so, may determine that the two drive recorders are mounted on the same vehicle.

### Processing Performed in Information Processing System 200

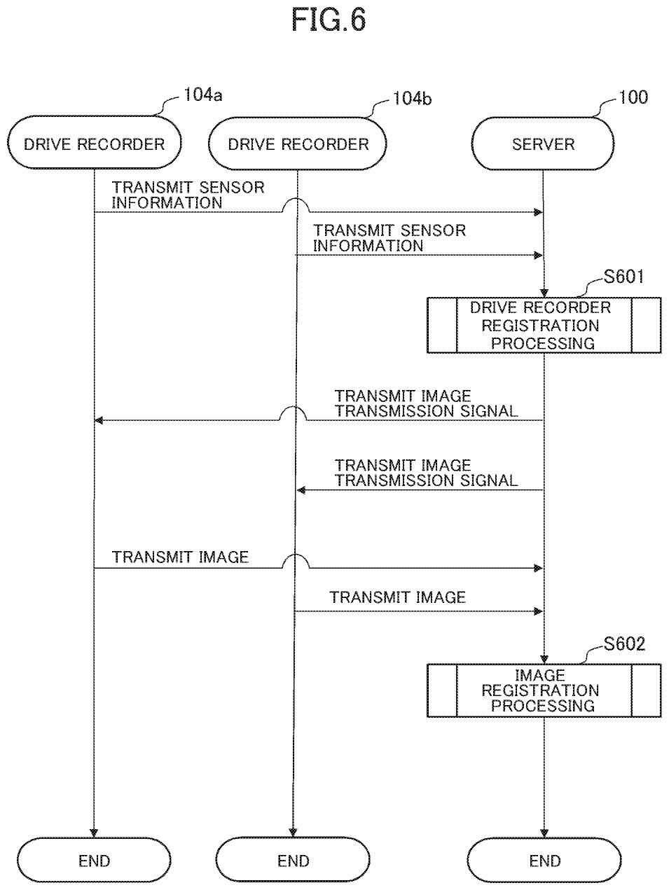

FIG. 6 is a timing chart illustrating an example of processing performed in the information processing system 200.

The plurality of drive recorders respectively transmit the plurality of pieces of sensor information to the server 100. Then, the server 100 compares the sensor information 1a with the sensor information 1b and performs the processing for associating the drive recorder 104a with the drive recorder 104b in accordance with the comparison result. Then, the server 100 performs processing (drive recorder registration processing) for registering the associated drive recorder 104a and drive recorder 104b in the storage memory 102 (step S601). Note that the drive recorder registration processing will be described below in detail.

Next, the server 100 transmits the image request signal to each of the associated drive recorder 104a and drive recorder 104b, to request the drive recorder 104a and the drive recorder 104b to transmit the captured image. Upon receiving the image request signal from the server 100, each of the plurality of drive recorders transmits the image captured by each of the plurality of drive recorders to the server 100.

Then, the server 100 associates the image 3a acquired from the drive recorder 104a with the image 3b acquired from the drive recorder 104b, and performs processing for registering the images in the storage memory 102 (image registration processing) (step S602). Note that the image registration processing will be described below in detail.

### Drive Recorder Registration Processing Performed by Server 100

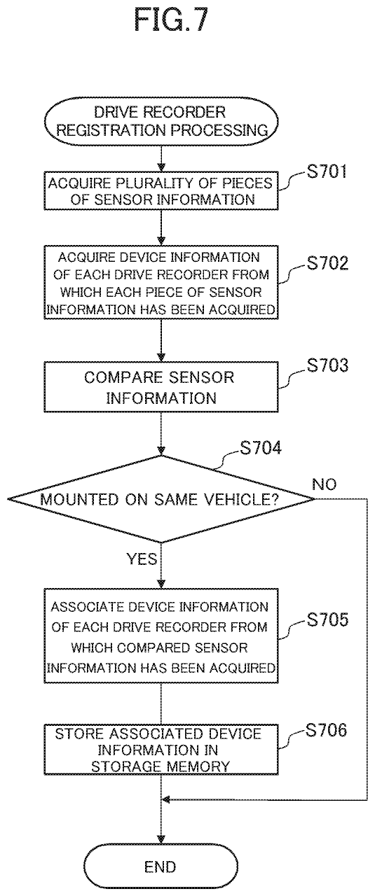

FIG. 7 is a flowchart illustrating an example of the drive recorder registration processing.

First, the acquisition unit 111 acquires the plurality of pieces of sensor information from the plurality of drive recorders (step S701). Next, the acquisition unit 111 acquires the device information from each of the plurality of drive recorders (step S702). Then, the comparison unit 113 compares the plurality of pieces of sensor information (step S703).

Next, the determination unit 114 determines whether the plurality of drive recorders are mounted on the same vehicle, in accordance with the result obtained by comparing the plurality of pieces of sensor information (step S704). When it is determined that the plurality of drive recorders are mounted on the same vehicle (Yes at step S704), the association unit 115 associates the plurality of drive recorders (step S705).

Finally, the storage unit 116 stores the group ID in the storage memory 102 as the unique identification information assigned to the plurality of pieces of device information respectively corresponding to the plurality of associated drive recorders (step S706).

Note that when the determination unit 114 determines that the drive recorders from which the sensor information has been acquired are not mounted on the same vehicle (No at step S704), the determination unit 114 terminates the processing.

### Image Registration Processing Performed by Server 100

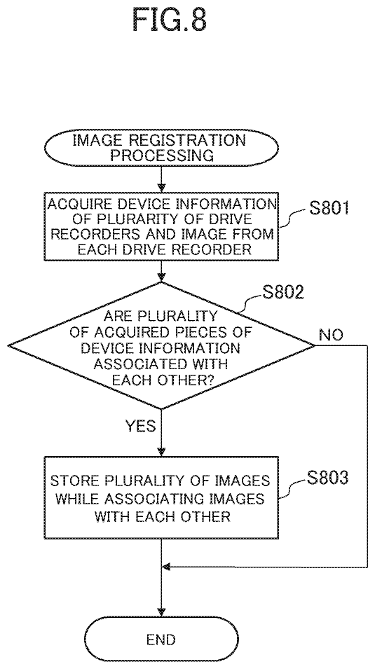

FIG. 8 is a flowchart illustrating an example of the image registration processing.

First, the image acquisition unit 112 acquires the image captured by each of the plurality of drive recorders and the device information corresponding to each of the plurality of drive recorders, from the plurality of drive recorders (step S801). Next, the determination unit 114 reads the group ID from the storage memory 102 and determines whether the plurality of drive recorders are associated with each other (step S802).

When it is determined that the plurality of drive recorders are associated with each other (Yes at step S802), the storage unit 116 stores the group ID and the above-described plurality of images in the storage memory 102, while associating the group ID with the plurality of images (step S803).

### Effect Achieved by Server 100

Since the server 100 can determine whether the two drive recorders are mounted on the same vehicle without requiring the user to take any trouble, the server 100 achieves an effect of being able to provide a wide range of services to the user, for example.

### Supplement

The above-described embodiment may be described in the following manner, but is not limited to the following mode.

An information processing device according to a first aspect of the present disclosure, for example, may include an acquisition unit configured to acquire a plurality of pieces of sensor information from a plurality of drive recorders, respectively, a comparison unit configured to compare first sensor information included in the plurality of pieces of sensor information with second sensor information included in the plurality of pieces of sensor information, and an association unit configured to associate, in accordance with a result of the comparison, a first drive recorder outputting the first sensor information and a second drive recorder outputting the second sensor information with each other, as two drive recorders mounted on the same vehicle.

With respect to the above-described first aspect, the information processing device according to a second aspect of the present disclosure, for example, may further include a determination unit configured to determine, in accordance with the result of the comparison, whether the first drive recorder and the second drive recorder are mounted on the same vehicle, and, when it is determined that the first drive recorder and the second drive recorder are mounted on the same vehicle, the association unit may associate the first drive recorder and the second drive recorder with each other.

With respect to the above-described second aspect, in the information processing device according to a third aspect of the present disclosure, for example, the comparison unit may evaluate a degree of similarity between the first sensor information and the second sensor information, and the determination unit may determine, in accordance with the degree of similarity, whether the first drive recorder and the second drive recorder are mounted on the same vehicle.

With respect to the above-described third aspect, in the information processing device according to a fourth aspect of the present disclosure, for example, the determination unit may determine that the first drive recorder and the second drive recorder are mounted on the same vehicle when the degree of similarity is within a prescribed range.

With respect to the above-described second to fourth aspects, in the information processing device according to a fifth aspect of the present disclosure, for example, the acquisition unit may acquire each of the plurality of pieces of sensor information in a time series manner, the comparison unit may compare the first sensor information and the second sensor information in a time series manner, and the determination unit may determine, in accordance with one of a time period and a number of times by which the result of the comparison satisfies a prescribed condition, whether the first drive recorder and the second drive recorder are mounted on the same vehicle.

With respect to the above-described first to fifth aspects, the information processing device according to a sixth aspect of the present disclosure may further include an image acquisition unit configured to acquire an image from each of the plurality of drive recorders, and a storage unit configured, when the first drive recorder and the second drive recorder are associated with each other, to store a first image acquired from the first drive recorder and a second image acquired from the second drive recorder in a storage memory while associating the first image and the second image with each other.

With respect to the above-described sixth aspect, the information processing device according to a seventh aspect of the present disclosure may further include an output unit configured to output the first image and the second image to a terminal used by a user while associating the first image and the second image with each other.

With respect to the above-described first to seventh aspects, in the information processing device according to an eighth aspect of the present disclosure, the acquisition unit may acquire user information identifying a user of the first drive recorder, and the association unit may further associate the user information and the second drive recorder with each other.

With respect to the above-described first to eighth aspects, in the information processing device according to a ninth aspect of the present disclosure, the acquisition unit may acquire information based on at least one of a position, acceleration, and vibration, as the plurality of pieces of sensor information.

An information processing system according to a tenth aspect of the present disclosure may include the information processing device according to any one of the above-described first to ninth aspects, and the plurality of drive recorders.

An information processing system according to an eleventh aspect of the present disclosure may include the information processing device according to any one of the above-described first to ninth aspects, and a user terminal configured to receive an image from the information processing device.

A control method of an information processing device according to a twelfth aspect of the present disclosure may include acquiring a plurality of pieces of sensor information from a plurality of drive recorders, respectively, comparing first sensor information included in the plurality of pieces of sensor information with second sensor information included in the plurality of pieces of sensor information, and associating, in accordance with a result of the comparison, a first drive recorder outputting the first sensor information and a second drive recorder outputting the second sensor information with each other, as two drive recorders mounted on the same vehicle.

A control program according to a thirteenth aspect of the present disclosure may cause an information processing device to realize an acquisition function that acquires a plurality of pieces of sensor information from a plurality of drive recorders, respectively, a comparison function that compares first sensor information included in the plurality of pieces of sensor information with second sensor information included in the plurality of pieces of sensor information, and an association function that, in accordance with a result of the comparison, associates a first drive recorder outputting the first sensor information and a second drive recorder that has second sensor information with each other, as two drive recorders mounted on the same vehicle.

Note that the disclosure is not limited to the above-described embodiments and modified examples and may be modified, and an above-described configuration can be replaced by substantially the same configuration, a configuration that achieves substantially the same operation and effect, or a configuration that can achieve the same object.

### Implementation Example by Software

A control block provided in the server 100 (each of the units included in the controller 110) may be implemented by software using a controller (a processor), such as a central processing unit (CPU). In other words, the server 100 includes a CPU that executes command of a control program, which is software for implementing each function, a read only memory (ROM) or a storage device (these are each referred to as a “recording medium”) that stores the control program and various types of data in a manner capable of being read by a computer (or the CPU), a random access memory (RAM) that develops the control program, and the like.

Then, the computer (or the CPU) reads the control program from the recording medium and executes the control program to achieve an example of the object of an aspect of the present disclosure. As the recording medium, a “non-transitory tangible medium”, such as a tape, a disk, a card, a semiconductor memory, and a programmable logic circuit may be used. Further, the control program may be supplied to the computer via a chosen transmission medium (a communication network, a broadcast wave, or the like) capable of transmitting the control program. Note that an aspect of the present disclosure may be implemented in the form of a data signal embedded in a carrier wave, in which the above-described control program is realized by electronic transmission.

Note that the control program can be implemented in any programming language. For example, the control program may be implemented using a scripting language such as ActionScript or JavaScript (trade name), an object-oriented programming language such as Objective-C and Java (trade name), a markup language such as HTML5, and the like. Further, a server that is provided with an information processing terminal (a smart phone or a personal computer, for example) provided with each of units that implement each function implemented by the control program, and with each of units that implement remaining functions other than each of the functions described above is also included within the scope of the present disclosure.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An information processing device comprising:
an acquisition unit configured to acquire a plurality of pieces of sensor information from a plurality of drive recorders, respectively;
a comparison unit configured to compare first sensor information included in the plurality of pieces of sensor information with second sensor information included in the plurality of pieces of sensor information; and
an association unit configured to associate, in accordance with a result of the comparison, a first drive recorder outputting the first sensor information and a second drive recorder outputting the second sensor information with each other, as two drive recorders mounted on a same vehicle.

2. The information processing device according to claim 1, further comprising:
a determination unit configured to determine, in accordance with a result of the comparison, whether the first drive recorder and the second drive recorder are mounted on the same vehicle,
wherein when it is determined that the first drive recorder and the second drive recorder are mounted on the same vehicle, the association unit associates the first drive recorder and the second drive recorder with each other.

3. The information processing device according to claim 2,
wherein the comparison unit evaluates a degree of similarity between the first sensor information and the second sensor information, and
the determination unit determines, in accordance with the degree of similarity, whether the first drive recorder and the second drive recorder are mounted on the same vehicle.

4. The information processing device according to claim 3,
wherein when the degree of similarity is within a prescribed range, the determination unit determines that the first drive recorder and the second drive recorder are mounted on the same vehicle.

5. The information processing device according to claim 2,
wherein the acquisition unit acquires each of the plurality of pieces of sensor information in a time series manner,
the comparison unit compares the first sensor information and the second sensor information in a time series manner, and
the determination unit determines, in accordance with one of a time period and a number of times by which the result of the comparison satisfies a prescribed condition, whether the first drive recorder and the second drive recorder are mounted on the same vehicle.

6. The information processing device according to claim 1, further comprising:
an image acquisition unit configured to acquire an image from each of the plurality of drive recorders; and
a storage unit configured, when the first drive recorder and the second drive recorder are associated with each other, to store a first image acquired from the first drive recorder and a second image acquired from the second drive recorder in a storage memory while associating the first image and the second image with each other.

7. The information processing device according to claim 6, further comprising:
an output unit configured to output the first image and the second image to a terminal used by a user while associating the first image and the second image with each other.

8. The information processing device according to claim 1,
wherein the acquisition unit acquires user information identifying a user of the first drive recorder, and
the association unit further associates the user information and the second drive recorder with each other.

9. The information processing device according to claim 1,
wherein the acquisition unit acquires information based on at least one of a position, acceleration, and vibration, as the plurality of pieces of sensor information.

10. An information processing system comprising:
the information processing device according to claim 1; and
the plurality of drive recorders.

11. An information processing system comprising:
the information processing device according to claim 1; and
a user terminal configured to receive an image from the information processing device.

12. A control method of an information processing device, the control method comprising:
acquiring a plurality of pieces of sensor information from a plurality of drive recorders, respectively;
comparing first sensor information included in the plurality of pieces of sensor information with second sensor information included in the plurality of pieces of sensor information; and
associating, in accordance with a result of the comparison, a first drive recorder outputting the first sensor information and a second drive recorder outputting the second sensor information with each other, as two drive recorders mounted on a same vehicle.
